(19) United States
(12) Patent Application Publication
(10) Pub. No.: US 2021/0229894 A1
(43) Pub. Date: Jul. 29, 2021

(54) THERMAL CONTAINER

(71) Applicant: CARTOTECNICA G. ARICI S.R.L., Collebeato (BS) (IT)

(72) Inventor: Massimo CORSINI, Collebeato (BS) (IT)

(73) Assignee: CARTOTECNICA G. ARICI S.R.L., Collebeato (BS) (IT)

(21) Appl. No.: 17/050,937

(22) PCT Filed: Apr. 3, 2019
(86) PCT No.: PCT/IB2019/052717

§ 371 Date: Oct. 27, 2020

(30) Foreign Application Priority Data
Apr. 27, 2018 (IT) 102018000004924

(51) Int. Cl. B65D 81/38; B65D 5/64; B65D 5/32; B31B 50/14

(52) U.S. Cl. CPC B65D 81/3853; B65D 81/386; B65D 81/3858; B31B 2120/10; B65D 5/321; B31B 50/142; B65D 5/64

(57) ABSTRACT

The invention refers to a thermal sealing container (1) for transporting a food product, warm or cold, and a relative making process, wherein the container comprises a first tray (2) and a lid (3) for the closing and opening of the first tray (2), wherein the first tray (2) and the lid (3) each comprise an inner wall (4; 11) and an outer wall (5; 12) that is opposing to, and at a predetermined distance from, the respective inner wall (4; 11), wherein the first tray (2) and the lid (3) each have at least one interspace (6; 13) comprised between the respective inner (4; 11) and outer (5; 12) walls, and wherein the first tray (2) and the first lid (3) are made of respective sheets of die cut cardboard.

### FIELD OF THE INVENTION

In its most general aspect, the present invention concerns a thermal container for food use and, in particular, the invention concerns a container of the aforesaid type for transporting a warm or cold food product.

### STATE OF THE ART

It is known to use thermal sealing containers for transporting food products from one place to another in the food sector.

Containers of the aforesaid type are for example widely used for transporting fresh ice cream.

The fresh ice cream purchased in an ice cream parlour, whenever not consumed right away, is in fact packaged in thermal sealing containers made of plastic, generally expanded polystyrene.

Although advantageous, the thermal sealing containers of plastic material provided in the known art are not free from drawbacks, among which the relevant negative impact they have on the environment.

In fact, it is known that all or almost all consumer products of plastic material, and particularly disposable products, are an abundant source of pollution nowadays.

### SUMMARY OF THE INVENTION

The technical problem underlying the present invention has been to provide a thermal sealing container for food use, and particularly a container of the aforesaid type for transporting warm or cold food products, having structural and functional characteristics such as to overcome the drawbacks mentioned above with reference to the known art.

According to the invention, the aforesaid problem is solved by a thermal container for transporting food products, warm or cold, comprising a first tray and a lid for the closing and opening of the aforesaid first tray, characterized in that the aforesaid first tray and the aforesaid lid each comprise an inner wall and an outer wall that is opposing to, and at a predetermined distance from, the respective inner wall, wherein the aforesaid first tray and the aforesaid lid each have at least one interspace comprised between the respective aforesaid inner and outer walls, and wherein the aforesaid first tray and the aforesaid lid are made of respective sheets of die cut cardboard.

Preferably, the aforesaid container comprises a second tray, wherein the aforesaid second tray is housed in the aforesaid first tray, possibly removably, and wherein the aforesaid second tray is made of a respective sheet selected from the group consisting of die cut cardboard, die cut thin cardboard, cut thin cardboard, die cut paper, cut paper.

Preferably, the aforesaid second tray comprises an inner wall and an outer wall that is opposing to, and at a predetermined distance from, the aforesaid inner wall, the aforesaid second tray preferably having an interspace comprised between the aforesaid inner wall and the aforesaid outer wall.

Preferably, in the aforesaid container, each of the aforesaid sheets of die cut cardboard of the aforesaid first tray and of the aforesaid lid comprises a sheet of thin cardboard and a plurality of sheets of corrugated thin cardboard coupled to the aforesaid sheet of thin cardboard, and more preferably also the aforesaid sheet of die cut cardboard of the aforesaid second tray comprises a sheet of thin cardboard and a plurality of sheets of corrugated thin cardboard coupled to the respective aforesaid sheet of thin cardboard.

Preferably, in the aforesaid container, the plurality of sheets of corrugated thin cardboard of a respective sheet of die cut cardboard is inside the respective interspace.

Preferably, the interspace of the aforesaid first tray and/or the interspace of the aforesaid lid and/or the interspace of the aforesaid second tray are substantially closed both with respect to the environment outside of the aforesaid container and to the environment inside the container itself.

With regard to this, the aforesaid first tray and/or the aforesaid lid and/or the aforesaid second tray preferably comprise respective edge walls which substantially close the respective interspace.

In particular, as far as the second tray is concerned, it must be noted that it more preferably comprises an elongated edge resting on, or overlapping, the edge wall of the first tray.

The aforesaid elongated edge of the second tray resting on, and overlapping, the edge wall of the first tray can be provided both in the event that the second tray comprises the interspace, therefore the aforesaid edge wall, and in the event that the second tray does not comprise a respective interspace.

Preferably, the thickness of the interspace of the aforesaid first tray is substantially equal to the thickness of the interspace of the aforesaid lid.

Preferably, the thickness of the interspace of the aforesaid first tray is greater than the thickness of the interspace of the aforesaid second tray.

Preferably, the aforesaid container comprises at least one sheet of plastic material, more preferably a sheet of polyethylene, combined, on one side of the aforesaid sheet of thin cardboard, with at least one of the aforesaid sheets of die cut cardboard, preferably the side opposite the side coupled to the aforesaid sheets of corrugated thin cardboard.

Preferably, the aforesaid sheets of die cut cardboard consist of a food-grade thin cardboard and/or a liquid-proof thin cardboard.

Preferably, the aforesaid container has a thermal resistance R equal to, or greater than, 0.25 mK/W.

According to the invention, the respective interspaces extend in the aforesaid first tray and in the aforesaid lid over the entire extent of the aforesaid first tray and of the aforesaid lid.

Therefore, in the aforesaid first tray, the respective interspace extends both sideways and at a respective bottom, while in the aforesaid lid, the respective interspace extends at a head wall and possibly sideways if the lid is provided with side walls or folded side edges which do not overlap the aforesaid interspace of the aforesaid first tray.

Preferably, the aforesaid container comprises combining means for constraining the aforesaid first tray and the aforesaid second tray to each other, wherein said combining means are preferably adhesive means.

According to the above and according to the present invention, the aforesaid problem is also solved by a process for making a thermal container of the aforesaid type, for which the above, to which reference is made, applies, and which comprises the steps of:
providing a first sheet of cardboard and a second sheet of cardboard;
die cutting the aforesaid first sheet of cardboard to make a first tray therefrom, and die cutting the aforesaid second sheet of cardboard to make a lid therefrom, wherein the aforesaid first tray and the aforesaid lid are intended to be coupled, i.e. to be combined, to each other;
in a forming machine, forming the aforesaid first tray from the aforesaid first sheet of die cut cardboard and forming the aforesaid lid from the aforesaid second sheet of die cut cardboard, wherein the aforesaid first tray and the aforesaid lid each comprise an inner wall and an outer wall that is opposing to, and at a predetermined distance from, the respective inner wall, wherein the aforesaid first tray and the aforesaid lid are each equipped with an interspace comprised between the respective inner and outer walls.

Preferably, the aforesaid process further comprises the steps of:
providing a third sheet of cardboard;
die cutting the aforesaid third sheet of cardboard to make a second tray therefrom, wherein the aforesaid second tray is intended to be removably housed inside the aforesaid first tray;
in a forming machine, forming the aforesaid second tray from the aforesaid third sheet of die cut cardboard, wherein preferably the aforesaid second tray comprises an inner wall and an outer wall that is opposing to, and at a predetermined distance from, the aforesaid inner wall, the aforesaid second tray having an interspace comprised between the aforesaid inner wall and the aforesaid outer wall;
inserting the aforesaid second tray inside the aforesaid first tray.

In practice, according to the present invention, a thermal sealing cardboard container, environmentally friendly and substantially biodegradable, is provided, comprising at least two layers of cardboard alternated with at least one interspace of air, which allows to maintain the temperature of a food product, warm or cold, contained inside it, substantially unvaried or otherwise subject to minimum variations for a period of time sufficient for the use to which the present container is intended, i.e. the short transport of a food product, generally equal to or less than 60 minutes.

### BRIEF LIST OF THE FIGURES

Further characteristics and advantages of the invention will be better highlighted by the review of the following detailed description of a preferred, but not exclusive, embodiment, illustrated by way of example and without limitations, with the aid of the accompanying drawings, in which:

FIG. 1 shows a cut-away and split-section view of a thermal container for transporting a warm or cold food product, comprising a first tray, a second tray intended to be removably housed inside the first tray, and a lid for the closing and opening of the first tray, therefore of the second tray, according to the present invention.

### DETAILED DESCRIPTION OF THE INVENTION

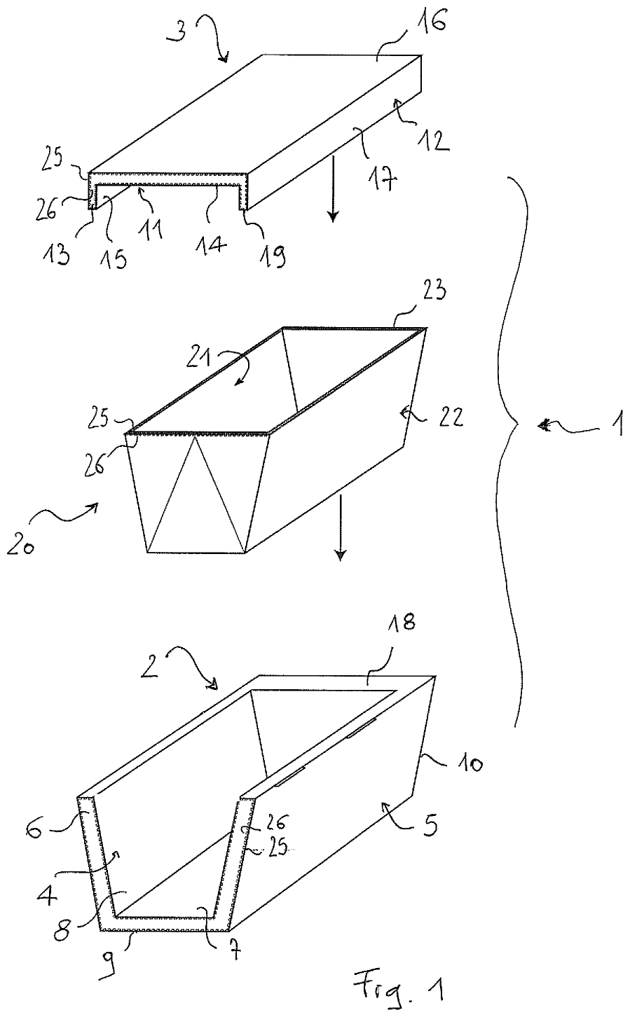

With reference to FIG. 1, 1 generally denotes a thermal sealing container for transporting food, according to the present invention.

In particular, the container 1 is apt for transporting both warm and cold foods, for example ice cream, and essentially comprises a first tray 2 and a lid 3 removably combined with the first tray 2, for the closing and opening of the first tray itself.

According to the invention, the first tray 2 and the lid 3 each comprises an inner wall and an outer wall that is opposing to, and at a predetermined distance from, the respective inner wall to form a respective interspace.

In detail, the first tray 2, which is obtained from a sheet of die cut cardboard herein identified also as first sheet, comprises an inner wall generally denoted by 4 and an outer wall generally denoted by 5, among which an interspace 6 is comprised.

The inner wall 4 comprises all the surfaces inside the first tray 2, therefore comprises an inner bottom surface 7 and inner side surfaces 8 which rise from the inner bottom surface 7.

Similarly, the outer wall 5 comprises an outer bottom surface 9 and outer side surfaces 10 which rise from the outer bottom surface 9.

Similarly, the lid 3, which is obtained from a sheet of die cut cardboard herein identified also as second sheet, comprises an inner wall generally denoted by 11 and an outer wall generally denoted by 12, among which an interspace 13 is comprised.

The inner wall 11 comprises all surfaces inside the lid 3, therefore comprises an inner head surface 14 and inner side surfaces 15 which develop from the inner head surface 14, while the outer wall 12 comprises an outer head surface 16 and outer side surfaces 17 which develop from the outer head surface 16.

An edge wall denoted by 18, which substantially closes the interspace 6 of the first tray 2, is comprised between the inner wall 4 and the outer wall 5 at a mouth of the first tray 2.

Similarly, an edge wall denoted by 19, which substantially closes the interspace 13 of the lid 3, is comprised between the inner wall 11 and the outer wall 12 of the lid 3.

According to the example of the figure, the container 1 further comprises a second tray 20 which, while using the container, can be internally constrained to the first tray or removably housed inside the first tray 2, in any case the second tray 20 being of smaller dimensions than the dimensions of the first tray 2.

According to the invention, the second tray 20 is also obtained with a sheet of die cut cardboard, herein also identified as third sheet, the possibility of making the second tray with a sheet of thin die cut cardboard, or cut thin cardboard, or die cut paper, or even cut paper is not however being excluded.

In detail, according to the example of the figure, the second tray 20 comprises an inner wall 21 and an outer wall 22 between which an interspace 23 is comprised, the possibility of providing a second tray without interspaces, i.e. with a single wall having an inner side and an outer side, is not however excluded, this embodiment not being in the figures illustrated.

Similarly to the aforesaid first tray, the inner wall 21 of the second tray 20 comprises all the surfaces inside the second tray, therefore comprises an inner bottom surface and inner side surfaces which rise from the inner bottom surface, while the outer wall 22 comprises an outer bottom surface and outer side surfaces which rise from the outer bottom surface.

An edge wall, which substantially closes the interspace 23 of the second tray 20, can be comprised between the inner wall 21 and the outer wall 22 of the second tray 20, or as shown in the example of the figure, the interspace 23 can substantially be open at a mouth of the second tray.

In alternative, the second tray can have an elongated edge resting on, and overlapping, the edge wall of the first tray, this embodiment not being in the figures shown.

As shown in the example of the figure, the sheet of die cut cardboard of the first tray 2, therefore the first sheet, the sheet of die cut cardboard of the lid 3, therefore the second sheet, and the sheet of die cut cardboard of the second tray 20, therefore the third sheet, each comprise a sheet of thin cardboard 25 and a plurality of sheets of corrugated thin cardboard, altogether denoted by 26 and coupled to the respective sheet of thin cardboard 25, wherein the sheets of corrugated thin cardboard 26 of each sheet of die cut cardboard are arranged inside the respective interspace.

Still according to the example of the figure, the thickness of the interspace 6 of the first tray 2 is greater than the thickness of the interspace 23 of the second tray 20, and substantially equal to the thickness of the interspace 13 of the lid 3.

In practice, the aforesaid thickness corresponds to the aforesaid predetermined distance between the inner wall and the outer wall of the first tray, the second tray or the lid, depending on the case.

Moreover, it should be noted that the container according to the present invention advantageously can comprise at least one sheet of plastic material combined, on one side of the sheet of thin cardboard 25, with at least one of the aforesaid sheets of die cut cardboard.

In particular, polyethylene is preferred among the plastic materials, and advantageously one sheet of polyethylene or other plastic material is combined with the side of the sheet of thin cardboard 25 opposite the side of the latter which is coupled to sheets of corrugated thin cardboard 26.

In practice, the sheet of polyethylene or other plastic material, not shown in the figures, is arranged at least on the inner wall of the first tray and/or on the inner wall of the second tray, if provided.

In alternative or in addition to the sheet or sheets of plastic material of the aforesaid type, one or more of the aforesaid sheets of die cut cardboard can consist of food-grade thin cardboard and/or liquid-proof thin cardboard of known type.

In practice, according to the invention, the present container is characterized by having a thermal resistance R equal to, or greater than, 0.25 mK/W.

The above thanks to the cardboard walls and interspace of the first tray, of the lid and possibly of the second tray, the interspaces extending over the entire extent of the inner and outer walls of the first tray itself, of the lid itself, and possibly of the second tray itself.

According to the above, the present invention further provides a process for making a thermal container of the aforesaid type, for which the above, to which reference is made, applies, and which comprises the steps of:
providing a first sheet of cardboard and a second sheet of cardboard;
die cutting the first sheet of cardboard to make a first tray therefrom, and die cutting the second sheet of cardboard to make a lid therefrom, wherein the first tray and the lid are intended to be coupled to each other;
in a forming machine, forming the first tray 2 from the first sheet of die cut cardboard and forming the lid 3 from the second sheet of die cut cardboard, wherein the first tray 2 and the lid 3 each comprises an inner wall and an outer wall that is opposing to, and at a predetermined distance from, the respective inner wall, wherein the first tray and the lid are each equipped with an interspace comprised between the respective inner and outer walls.

According to the example of the figure, the present process further comprises the steps of:
providing a third sheet of cardboard;
die cutting the third sheet of cardboard to make a second tray therefrom, wherein the second tray is intended to be removably housed inside the first tray;
in a forming machine, forming the second tray 20 from the third sheet of die cut cardboard, wherein preferably, and similarly to the above, the second tray 20 comprises an inner wall 21 and an outer wall 22 that is opposing to, and at a predetermined distance from, the inner wall 21, wherein the second tray 20 is equipped with an interspace 23 comprised between the inner wall 21 and the outer wall 22;
inserting, i.e. housing, the second tray 20 inside the first tray 2, thus obtaining the container 1.

In practice, according to the invention, the aforesaid sheets of cardboard are obtained by a traditional molding technique of the relative thin cardboards, with subsequent coupling with the sheets of corrugated thin cardboard, having the thickness necessary for the necessary rigidity of the container and its thermal resistance.

The cardboard sheets are therefore subjected to die cutting, and the sheets of die cut cardboard are then processed in a forming machine which transforms each sheet of die cut cardboard into the relative element of the container by performing appropriate folds, i.e. in the first tray, in the lid and possibly in the second tray. The aforesaid interspaces are also obtained in this step.

Lab tests carried out on the container according to the present invention have demonstrated that the insulating capacity of the container is very similar to that of a container in expanded polystyrene of the known type available on the market and used for transporting ice cream.

For example, by introducing frozen ice cubes in the present container, with an ambient temperature equal to 21±2° C. outside of the container, there is an increase in the temperature of the air pad between the second tray and the lid, from −14° C. to −11° C. after one hour, substantially independently of the shape and dimensions of the container, which can therefore be obtained in different dimensions and in any shape compatible with the forming step.

Still with frozen ice cubes and with an ambient temperature of 21±2° C. outside of the container, a maximum increase of the temperature of about 4° C. was measured over a 1 hour period, in containers according to the present invention comprising the first tray and the lid and without the second tray.

As stated, the increase of the temperature inside the present container in a predetermined time interval is substantially independent of the shape and dimensions of the container, while it mostly depends on the width of the walls and on the interspaces of the first tray and the lid, and possibly on the second tray, on the type of material used, on the temperature outside of the container, and less on the type of food product contained therein, on the quantity and the temperature of the latter.

As far as the aforesaid thermal resistance R is concerned, it can briefly be remembered that it is defined, for a given material, as the ratio between the thickness of the material and its thermal conductivity λ which is a coefficient that expresses the capacity of the material to conduct heat.

With reference to the UNI 7357-54 regulation, we have for example:

λ Corrugated cardboard: 0.064 W/mK

λ Expanded polystyrene: 0.035 W/mK

λ Air: 0.026 W/mK

and R=s/λ

### EXAMPLES

Heat Drop Test

A first container and a second container made of cardboard, each comprising a first tray, a lid for the closing and opening of the first tray, and a second tray housed inside the first tray, wherein the first tray, lid and second tray each comprised a respective interspace, according to the present invention, were tested.

First Container

The first container, obtained from a sheet of g. 270 bg sq.m. stretched thin cardboard coupled to sheets of corrugated thin f/tbm/34 cardboard, presented:

first tray interspace (air), substantially closed, equal to 1 cm,

lid interspace (air), substantially closed, equal to 1 cm,

first tray, outer and inner walls each of 1.5 mm,

lid, outer and inner walls each of 1.5 mm,

wall of second tray, 1.1 mm.

The second tray without interspace was substantially adhering to the first tray.

The capacity of the second tray was equal to 1 liter.

Ice cream in a quantity equal to 1.0 Kg was poured in the first container, in which the ice cream was previously subjected to a temperature of −18±1° C., for 4 hours (4 hrs.) in a package of expanded plastic material according to the known art, particularly a package of expanded polystyrene of capacity of 1 liter with thickness of the walls equal to 1.2 cm, containing a quantity of ice cream equal to 1 kg.

Immediately after transferring the ice cream from the package of expanded plastic material to the first container, the first container was placed in a stove at a temperature of +30±1° C.

A thermocouple was inserted inside the first container to verify the heat drop of the ice cream within a predetermined time interval corresponding to 30 minutes.

The temperature inside the first container began to gradually increase after about 2 minutes, and at the end of the 30-minute time interval provided for the test, the temperature measured inside the first container was equal to −10.7° C. with a heat drop equal to 7.3° C.

Second Container

The second container obtained from a sheet of thin mini micro F/KKK/999 cardboard with three white papers presented:

first tray interspace (air), substantially closed, equal to 1 cm,

lid interspace (air), substantially closed, equal to 1 cm,

first tray, outer and inner walls each of 1.1 mm,

lid, outer and inner walls each of 1.1 mm,

wall of second tray, 1.1 mm.

The second tray without interspace was substantially adhering to the first tray.

The capacity of the second tray was equal to 1 liter.

Ice cream in a quantity equal to 1 Kg was poured in the second container, in which the ice cream was previously subjected to a temperature of −18±1° C., for 4 hours (4 hrs.) in a package of expanded plastic material according to the known art, particularly a package of expanded polystyrene of capacity of 1 liter with thickness of the walls equal to 1.2 cm, containing a quantity of ice cream equal to 1.0 kg.

Immediately after transferring the ice cream from the package of expanded plastic material to the second container, the second container was placed in a stove at a temperature of +30±1° C.

A thermocouple was inserted inside the second container to verify the heat drop of the ice cream within a predetermined time interval corresponding to 30 minutes.

The temperature inside the second container began to gradually increase after about 2 minutes, and at the end of the 30-minute time interval provided for the test, the temperature measured inside the second container was equal to −12.6° C., with a heat drop equal to 5.4° C.

The advantages of the present invention, already clear from the description set forth above, can be summarized by pointing out that an environmentally friendly thermal sealing container is provided, particularly a cardboard container and possibly also of paper, comprising at least two layers of cardboard alternated with at least one interspace of air, which allows to maintain the temperature of a warm or cold food product housed inside it substantially unvaried, or anyhow subject to minimal variations, for a time period sufficient for the use to which the present container is intended, generally less than 60 minutes.

The present container, consisting of, or in practice essentially made of, biodegradable cardboard, therefore biodegradable paper, can advantageously and easily be further customized during the making process, for example by printing a desired graphic directly on the sheets of cardboard, without adding further material to the container.

In order to meet incidental and specific requirements, several variations and modifications could be made by a field technician to the illustrated and described embodiments of present invention, provided that all are included in the scope of protection of the invention as defined by the following claims.

1. Thermal container for transporting a food product, comprising: a first tray (2) and a lid (3) for closing and opening said first tray (2), said first tray (2) and said lid (3) each comprise an inner wall (4; 11) and an outer wall (5; 12) that is opposing to, and at a predetermined distance from, the respective inner wall (4; 11), said first tray (2) and said lid (3) each have at least one interspace (6; 13) comprised between the respective inner (4; 11) and outer (5; 12) walls, said first tray (2) and said lid (3) being made of respective sheets of die cut cardboard.

2. The thermal container according to claim 1, further comprising a second tray (20), wherein said second tray is housed in said first tray, (2) and wherein said second tray is made of a respective sheet selected from the group consisting of: die cut cardboard, die cut thin cardboard, cut thin cardboard, die cut paper, and cut paper.

3. The thermal container according to claim 2, wherein said second tray (20) comprises an inner wall (21) and an outer wall (22) that is opposing to, and at a predetermined distance from, said inner wall (21), said second tray (20) having an interspace (23) comprised between said inner wall (21) and said outer wall (22).

4. The thermal container according to claim 1, wherein each of said sheets of die cut cardboard comprises a sheet of thin cardboard (25) and a plurality of sheets of corrugated thin cardboard (26) coupled to said sheet of thin cardboard (25).

5. The thermal container according to claim 4, wherein the plurality of sheets of corrugated thin cardboard (26) of a respective die cut cardboard is inside the respective interspace.

6. The thermal container according to claim 1, wherein said at least one interspace (6) is substantially closed.

7. The thermal container according to claim 3, wherein a thickness of the at least one interspace (6) of said first tray (2) is greater than a thickness of the interspace (23) of said second tray (20).

8. The thermal container according to claim 4, further comprising at least one sheet of plastic material combined, on one side of said sheet of thin cardboard, with at least one of said sheets of die cut cardboard.

9. The thermal container according to claim 1, wherein said sheets of die cut cardboard is food-grade thin cardboard and/or liquid-proof thin cardboard.

10. The thermal container according to claim 2, wherein said first tray (2) comprises an edge wall (18) which substantially closes said at least one interspace (6), and wherein said second tray (20) comprises an elongated edge resting on, and overlapping, said edge wall (18) of said first tray (2).

11. The thermal container according to claim 1 having a thermal resistance R equal to, or greater than, 0.25 mK/W.

12. Process for making a thermal container for transporting a food product according to claim 1, the method comprising:
providing a first sheet of cardboard and a second sheet of cardboard;
die cutting said first sheet of cardboard to make a first tray (2) therefrom, and die cutting said second sheet of cardboard to make a lid (3) therefrom, wherein said first tray and said lid are configured to be combined with one another;
forming, in a forming machine, said first tray (2) from said first sheet of die cut cardboard and forming said lid (3) from said second sheet of die cut cardboard, wherein said first tray and said lid each comprise an inner wall (4; 11) and an outer wall (5; 12) that is opposing to, and at a predetermined distance from, the respective inner wall, wherein said first tray (2) and said lid (3) are each equipped with an interspace (6; 13) comprised between the respective inner and outer walls.

13. The process according to claim 12, further comprising:
providing a third sheet of cardboard;
die cutting said third sheet of cardboard to make a second tray (20)
therefrom, wherein said second tray is intended to be removably housed inside said first tray (2);
forming, in a forming machine, said second tray (20) from said third sheet of die cut cardboard, wherein said second tray comprises an inner wall (21) and an outer wall (22) that is opposing to, and at a predetermined distance from, said inner wall (21), said second tray (20) having an interspace (23) comprised between said inner wall (21) and said outer wall (22);
inserting said second tray (20) inside said first tray (2).
